(19) United States
(12) Patent Application Publication
(10) Pub. No.: US 2006/0231303 A1
(43) Pub. Date: Oct. 19, 2006

(54) Child's riding vehicle

(76) Inventors: Eric Fobean, Stow, OH (US); G. Stewart Lenox, Wadsworth, OH (US)

Correspondence Address: Cynthia S. Murphy;Renner, Otto, Boisselle & Sklar, LLP, Nineteenth Floor, 1621 Euclid Avenue, Cleveland, OH, 44115, US

(21) Appl. No.: 11/100,011

(22) Filed: Apr. 6, 2005

(51) Int. Cl. B60K 1/00

(52) U.S. Cl. 180/65.1

(57) ABSTRACT

A child's riding vehicle includes a shifter (40) for shifting the drive assembly among a forward-high condition, a forward-low condition, and a reverse-low condition. The shifter (40) has a direction switch (72) with a direction switch toggle (102) movable between a forward-direction position and a reverse-direction position and speed switch (74) with a speed switch toggle (108) movable between a high-speed position and a low-speed position. An actuator (76) is movable among a forward-high setting, a forward-low setting, and a reverse-low setting and, during this movement, interacts with the direction switch (72) and the speed switch (74) to shift the drive assembly among the forward-high condition, the forward-low condition and the reverse-low condition.

### FIELD OF THE INVENTION

This invention relates generally to a child's riding vehicle and, more particularly, to a vehicle for a child that can be operated at different speeds (i.e., fast and slow) and in different directions (i.e., forward and reverse).

### BACKGROUND OF THE INVENTION

Children enjoy mimicking adult behavior and the driving of vehicles is certainly no exception. For this reason, riding vehicles, and especially those modeled after cars and trucks driven by adults, are appealing to children. A child's riding vehicle will typically comprise a vehicle body adapted to carry a child, wheels rotatably connected to a drive assembly for driving the wheels. A shifter can be provided to allow operation of the vehicle at different speeds (e.g., fast and slow) and/or in different directions (i.e., forward and reverse).

### SUMMARY OF THE INVENTION

A child's riding vehicle comprises a vehicle body adapted to carry a child, wheels rotatably connected to the drive assembly, a drive assembly for driving the wheels, and a shifter for shifting the drive assembly among a forward-high condition (whereat it drives the wheels forward at a high speed), a forward-low condition (whereat it drives the wheels forward at a low speed), and a reverse-low condition (whereat it drives the wheels in reverse at a low speed).

The shifter comprises a direction switch including a toggle movable between a forward-direction position and a reverse-direction position, a speed switch including a toggle movable between a high-speed position and a low-speed position, and actuator. The direction switch is in the forward-direction position when the drive assembly is in the forward-high condition and the forward-low condition and the direction switch is in the reverse-direction position when the drive assembly is in the reverse-low condition. The speed switch is in the high-speed position when the drive assembly is in the forward-high condition, and the speed switch is in the low-speed position when the drive assembly is in the forward-low condition and when the drive assembly is in the reverse-low condition.

The shifter further comprises an actuator that is movable among a forward-high setting, a forward-low setting, and a reverse-low setting. When moved from setting to setting, the actuator interacts with the direction switch and the speed switch to shift the drive assembly among the forward-high condition, the forward-low condition and the reverse-low condition. To this end, the actuator can include a direction-switch-interacting slot, into which the direction switch toggle is inserted when it is moved between the forward-direction position and the reverse-direction position, and a speed-switch-interacting slot, into which the speed switch toggle is inserted when it is moved between the high-speed position and the low-speed position. Additionally or alternatively, the actuator can be pivotal about a pivot axis that is substantially parallel with the pivot axes of the direction and speed switch toggles.

When the actuator is moved between the forward-high, forward-low, and the reverse-low settings, the direction and speed switch toggles move between their front and rear positions. Because of the parallel arrangement of the pivot axes, the movement of the actuator translates into motion in the same parallel direction for the switch toggles. This movement of the actuator can provide a child who is driving the vehicle with a gear-shifting-feel that accurately resembles the sensation of shifting gears in an adult-size vehicle.

These and other features of the invention are fully described and particularly pointed out in the claims. The following description and annexed drawings set forth in detail a certain illustrative embodiment of the invention, this embodiment being indicative of but one of the various ways in which the principles of the invention may be employed.

### DRAWINGS

FIG. 1 is a perspective view of a child's riding vehicle according to the present invention, the vehicle including a shifter allowing operation of the vehicle at different speeds (e.g., fast and slow) and/or in different directions (i.e., forward and reverse);

FIG. 2 is a perspective view of the shifter isolated from the rest of the riding vehicle.

FIG. 3 is a side view of the shifter with its housing removed.

FIG. 4 is a perspective view of the shifter with its housing removed.

FIGS. 5A-5H are schematic views showing operation of the shifter.

FIG. 6 is a schematic view of an electrical circuit for establishing operative interaction between the shifter and the other relevant components of the drive assembly.

FIG. 7A-7C are schematic views showing a high-speed-lockout feature of the shifter.

### DETAILED DESCRIPTION

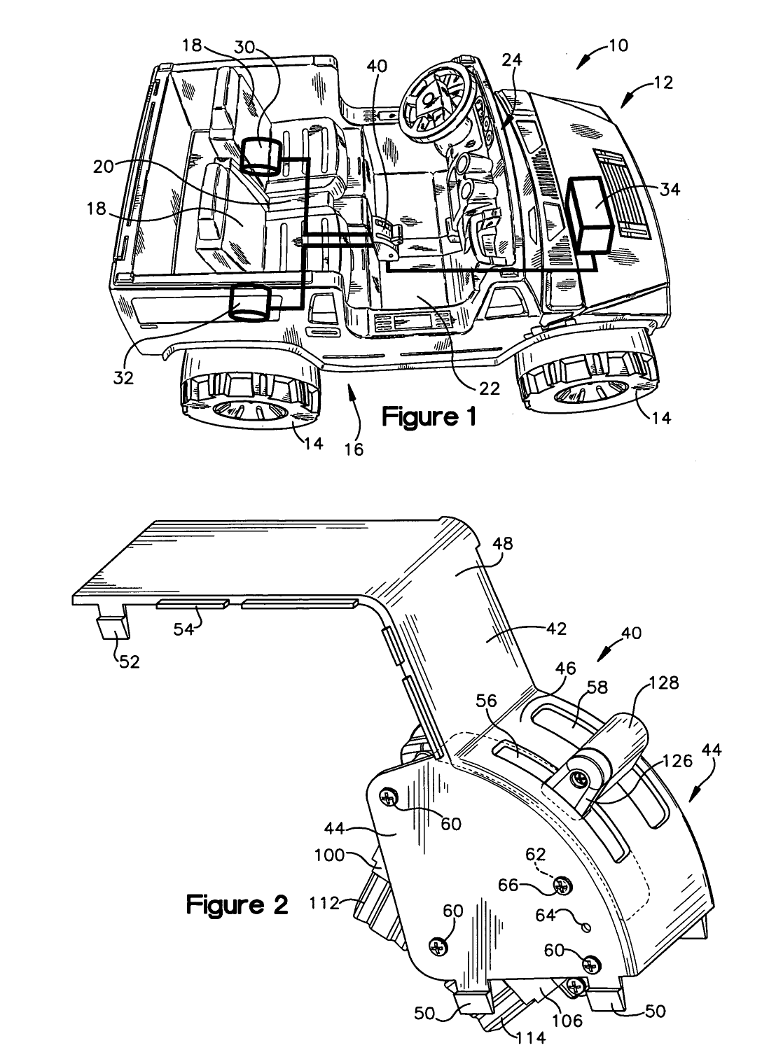

Referring now to the drawings, and initially to FIG. 1, a child's riding vehicle 10 according to the present invention is shown. The vehicle 10 generally includes a vehicle body 12 adapted to carry at least one child, wheels 14 rotatably connected to the vehicle body 12, and a drive assembly 16 for driving the wheels 14. In the illustrated embodiment, the vehicle 10 is modeled to resemble an adult-drive off-road vehicle, namely a model of the Hummer® vehicles offered by General Motors Corporation. That being said, the vehicle 10 may take on any form adapted to simulate real vehicles in a reduced scale, such as, for example, a car, truck, jeep, bus, motorcycle, carriage, tractor, construction equipment, etc.

The vehicle body 12 is typically formed of a plurality of molded, rigid, plastic parts that can be glued, melted or screwed together with suitable fasteners and can be adapted to include many of the features found in automotive vehicles driven by adults. For example, the illustrated vehicle 10 includes two seats 18, each sized to receive a seated child, and a dividing island 20 positioned between the seats 18. A floor 22 extends from the seats 18 to the region of the vehicle body 12 forming the dashboard 24.

The drive assembly 16 can comprise motor means, a power source for powering the motor means, and other components (e.g., linkages, axles, cables, etc.) for establishing operative interconnection between the wheels 14 and the motor means. In the illustrated embodiment, the motor means comprises motors 30 and 32 and the power source comprises a battery 34. A foot switch (not shown), or other activating means, can be provided for selective energization of the motor means 30/32 by a child.

The drive assembly 16 further comprises a shifter 40 which is operably coupled between the motor means 30/32 and the power source 34. The shifter 40 allows shifting of the drive assembly 16 among a forward-high condition whereat it drives the wheels 14 forward at a high speed, a forward-low condition whereat it drives the wheels 14 forward at a low speed, and a reverse-low condition whereat it drives the wheels 14 in reverse at a low speed. Preferably, the shifter 40 precludes a condition whereat the drive assembly 16 drives the wheels 14 in reverse at a high speed.

Referring now to FIG. 2, the shifter 40 is shown removed from the rest of the vehicle 10. The shifter 40 comprises a housing 42 that is fixed to the vehicle body 12 and that can comprise a pair of side walls 44, a top wall 46, and an extension wall 48. In the illustrated embodiment, the side walls 44 each have a quarter-circle shape, the top wall 46 has a corresponding curved arc shape, and the extension wall 48 has an L-like shape. The walls 44, 46, and 48 can be integrally formed (e.g., molded in one piece), as shown, or can be separate pieces joined together in an appropriate manner.

The housing walls 44 and 46 form a chamber for internal components of the shifter 40. As is best seen by referring briefly back to FIG. 1, this chamber is located on a region of the floor 22 which is longitudinally aligned with the space between the seats 18. The extension wall 48 extends upward to the upper edge of the top wall 46 and then rearward for integration into the seat-dividing island 20 of the vehicle body 12. The side walls 44 can have connection tabs 50 for mating with complimentary slots in the vehicle floor 22. The extension wall 48 can likewise have connection tabs/projections 52 and 54 for mating with complimentary components in the seat-dividing island 20.

The top wall 46 has a slot 56 and an indent channel 58 positioned roughly parallel therewith. The slot 56 is sized/shaped so that an actuating portion of the shifter 40 (namely an actuator handle portion 126, introduced below) can extend therethrough and be moved therewithin to control the setting of the shifter 40. The indent channel 58 can be labeled with indicia identifying the different settings of the shifter 40, specifically, for example, a “2” for the setting corresponding to the forward-high condition, a “1” for the setting corresponding to the forward-low condition, and a “R” for the setting corresponding to the reverse-low condition.

The side wall 44 visible in FIG. 2 includes three openings for accommodating fastening screws 60 which, as explained below, join internal shifter components to the housing 42. (The other side wall 44 can include similar openings for accommodating similar fastening screws.) The visible side wall 44 can also include an opening 62 and opening 64 for selective receipt of a screw 66. As is explained below, when the screw 66 is in the opening 62, the shifter 40 cannot be placed in a setting corresponding to the forward-high condition and thus is prevented from engaging in forward high speed operation. The other opening 64 is provided as a storage location for the screw 66 when it is removed from the opening 62 and forward-high operation is possible.

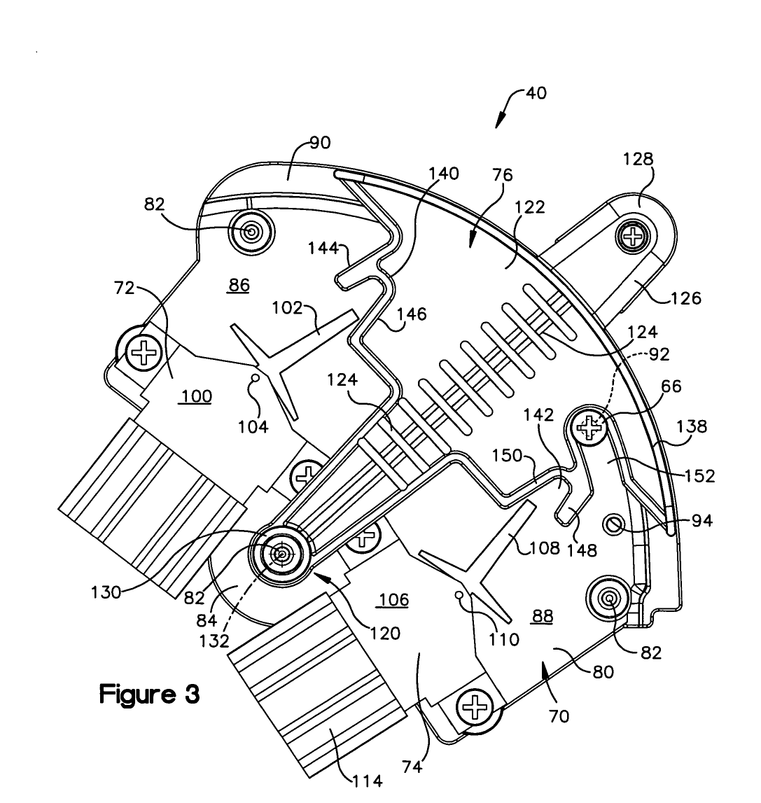

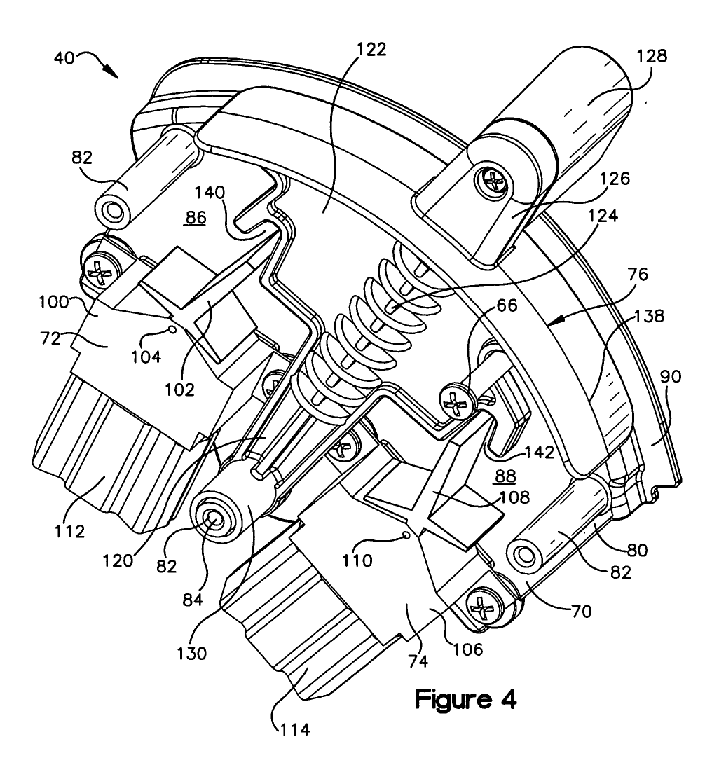

Referring now to FIGS. 3 and 4, the shifter 40 is shown with its housing 42 removed for a better view of the components within the chamber formed by the side and top walls 44 and 46. These internal shifter components include a frame 70, a direction switch 72, a speed switch 74, and an actuator 76. As is explained in more detail below, movement of the actuator 76 relative to the frame 70 controls the position of the switches 72 and 74 which in turn controls direction and speed at which the motors 30/32 drive the wheels 14.

The frame 70 comprises a main plate 80 having a shape generally corresponding to the chamber formed by the housing walls 44/46. Three cylindrical screw holders 82 extend perpendicularly from the main plate 80 and are arranged for receipt of the fastening screws 60. The frame 70 can further comprise a flange on upper edge 90 along the top edge of the main plate 80 which, as explained below, forms a track for the actuator 76.

The area including and surrounding the bottom-rear plate-to-housing screw holder 82 may be referred to as the pivot area 84 of the main plate 80 (and/or the frame 70). The area between the pivot area 84 and the plate-to-housing screw holder 82, and the area between the pivot area 84 and the bottom-front plate-to-housing screw holder 82, can be referred to as the direction and speed switch-interacting areas 86 and 88, respectively. As explained below, the actuator 76 is pivotally connected to the main plate 80 (and/or the frame 70) in the pivot area 84, the actuator 76 interacts with the direction switch 72 in the area 86, and the actuator 76 interacts with the speed switch 74 in the area 88.

The speed-switch-interacting area 88 of the main plate 80 (or an area just thereabove) includes an opening 92 and another opening 94 in front thereof. The opening 92 is aligned with the opening 62 in the housing 42 for receipt of the high-speed lockout screw 66. The storage opening 94 is aligned with the opening 64 in the housing 42 and likewise serves as a storage location for the screw 66 when a high-speed lockout is not required and/or desired.

The direction switch 72 comprises a casing 100 and a projecting toggle 102 pivotally connected to the casing 100 and movable about a pivot axis 104 between a front (first) position and a rear (second) position. The speed switch 74 comprises a casing 106 and a projecting toggle 108 pivotally connected to the casing 106 and movable about a pivot axis 110 between a front (first) position and a rear (second) position.

In the illustrated embodiment, the front position of the direction-switch toggle 102 is its forward-direction position and the rear position of the toggle 102 is its rear-direction position. Also, the front position of the speed-switch toggle 108 is its high-speed position and the rear position of the toggle 108 is its low-speed position. In FIGS. 3 and 4, the direction-switch toggle 102 is shown in its front forward-direction position and the speed-switch toggle 108 is shown in its rear low-speed position.

The casing 100 is secured to the main plate 80 so that the direction switch toggle 102 projects into the interacting area 86 and the casing 106 is secured to the main plate 80 so that the speed-switch toggle 108 projects into the interacting area 88. It may be noted for future reference that the pivot axes 104 and 110 are substantially parallel and perpendicular to the plane of the main plate 80. The switches 72/74 can each additionally include a wire harness 112/114 which electrically conveys the position of the toggle 102/108 to the appropriate circuitry (e.g., circuit 160, introduced below) of the drive assembly 16.

The actuator 76 can have a roughly mushroom-like shape with a stem portion 120 and a head portion 122 which share a central axis portion 124. The illustrated actuator 76 further includes a handle portion 126 which is coextensive with the central axis portion 124 and extends upward from the stem portion 120. The portions 120, 122, 124, and 126 are preferably integral with each other (e.g., molded as one piece) and the central axis portion 124 can be ribbed, as shown, for strength-imparting purposes.

As is best seen by referring briefly back to FIG. 2, the portions 120, 122 and 124 are positioned within the housing walls 44/46 in the assembled shifter 40. The handle portion 126 extends through the slot 56 in the housing's top wall 46 so as to be accessible from outside the housing 40. A separate handle attachment 128 can be provided for attachment to the distal end of the handle portion 126 after it has been inserted through the slot 56. In any event, as is best seen by referring briefly back to FIG. 1, the handle portion 126 can be gripped by a child sitting in the driver's seat 18 and to control the setting of the shifter 40 in much the same way as shifting is accomplished in an adult-size vehicle.

The bottom end of the stem portion 120 is pivotally attached to the pivot area 84 of the main plate 80 so that the actuator 76 can be moved relative to the housing 40 and the frame 70. In the illustrated embodiment, this pivotal attachment is accomplished by the stem portion 120 having a sleeve 130 which receives the lower bottom plate-to-housing screw holder 82 of the main plate 80 in a bearing-like manner. The actuator 76 can thereby move relative to the frame 70 about a pivot axis 132 among a forward-high setting, a forward-low setting, and a reverse-low setting to place the drive assembly 16 in the forward-high condition, the forward-low condition and the reverse-low condition, respectively.

The actuator pivot axis 132 is substantially perpendicular with the main plate 80 and, in any event, is substantially parallel with the pivot axes 104 and 110 of the switches 72 and 74. Additionally or alternatively, the actuator 72 moves in a plane as it moves among the forward-high setting, the forward-low setting, and the reverse-low setting. This plane of movement is non-parallel with, and substantially perpendicular to, the pivot axes 104 and 110 of the switches 72 and 74.

As was alluded to above, and as explained in more detail below, front/rear movement of the actuator 76 results in movement of the toggles 102/108 between their front positions and their rear positions. The parallel arrangement of the pivot axes 104, 110 and 132 results in the force applied to move the actuator 76 being applied in the same parallel direction to the toggles 102/108 for movement thereof. This force-application pattern can provide a child driving the vehicle 10 with a gear-shifting-feel that accurately resembles that which is experienced in an adult-size vehicle.

Turning now to the head portion 122 of the actuator 76, it can include a flange 138 along its upper edge which, during pivotal movement of the actuator 76, slides along the track formed by the flange 90 on the upper edge of the frame plate 80. The head portion 122 is also the switch-interacting portion of the actuator 76 and, to this end, includes switch-interacting slots 140 and 142. The direction-switch-interacting slot 140 is formed in a rear region of the lower edge of the head portion 122 and includes a front (first) wall 144 and a rear (second) wall 146. The speed-switch-interacting slot 142 is formed in a front region of the lower edge of the head portion 122 and includes a front (first) wall 148 and a rear (second) wall 150. It may be noted for future reference that the outer slot walls 146 and 148 (i.e., the rear wall 146 of the slot 140 and the front wall 148 of the slot 142) are shorter than the inner slot walls 144 and 150 (i.e., the front wall 144 of the slot 140 and the rear wall 150 of the slot 142).

The head portion 122 includes a high-speed lockout slot 152 located above the speed-switch-interacting slot 142. This slot 150 receives the high-speed lockout screw 66 when it is inserted through the high-speed lockout opening 62 in the housing 42 and the high-speed lockout opening 92 in the main plate 80. Likewise, the high-speed lockout slot 152 will not interact with the high-speed lockout screw 66 when it is placed in the storage openings 64 and 94.

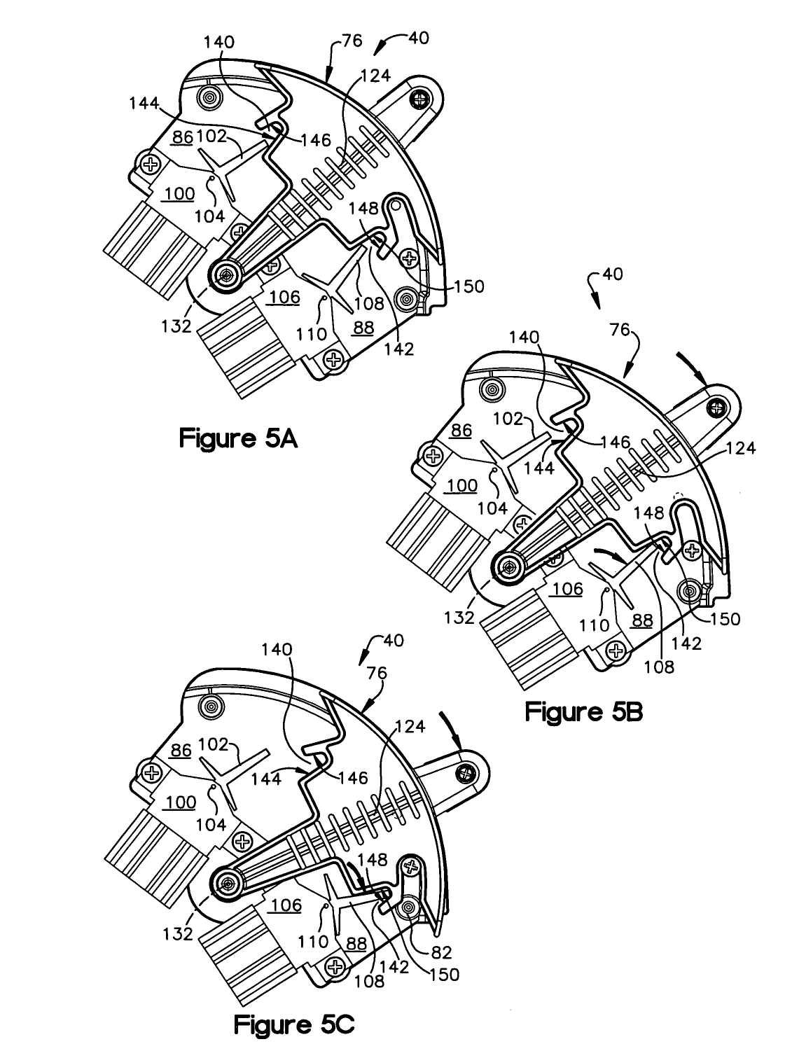

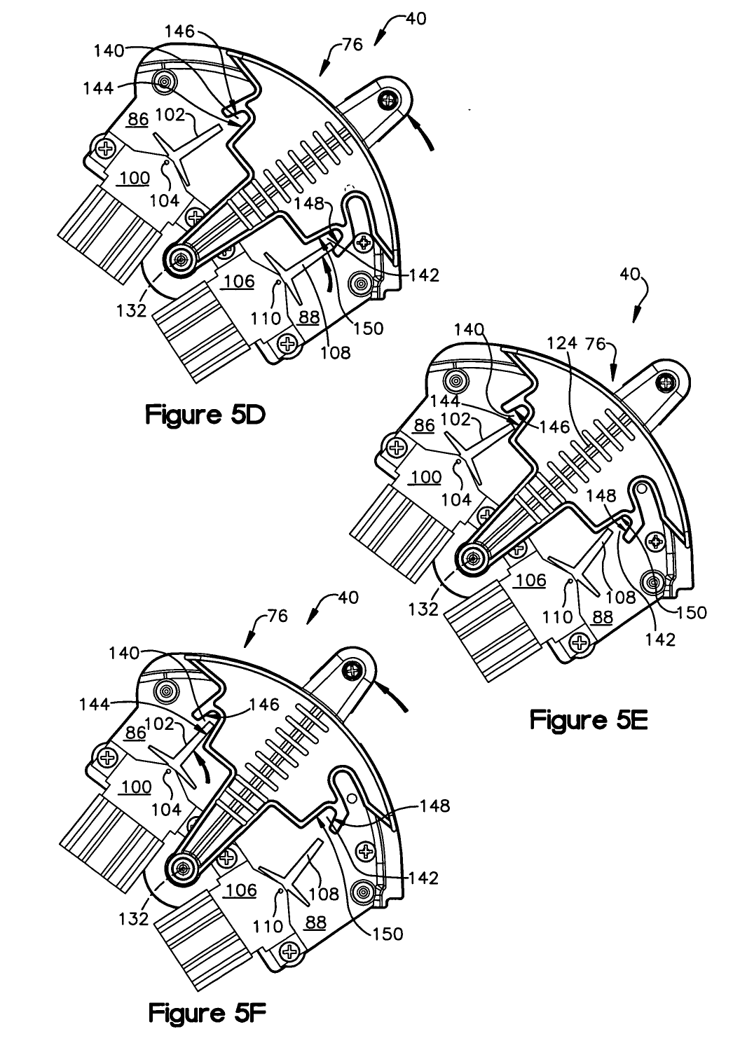

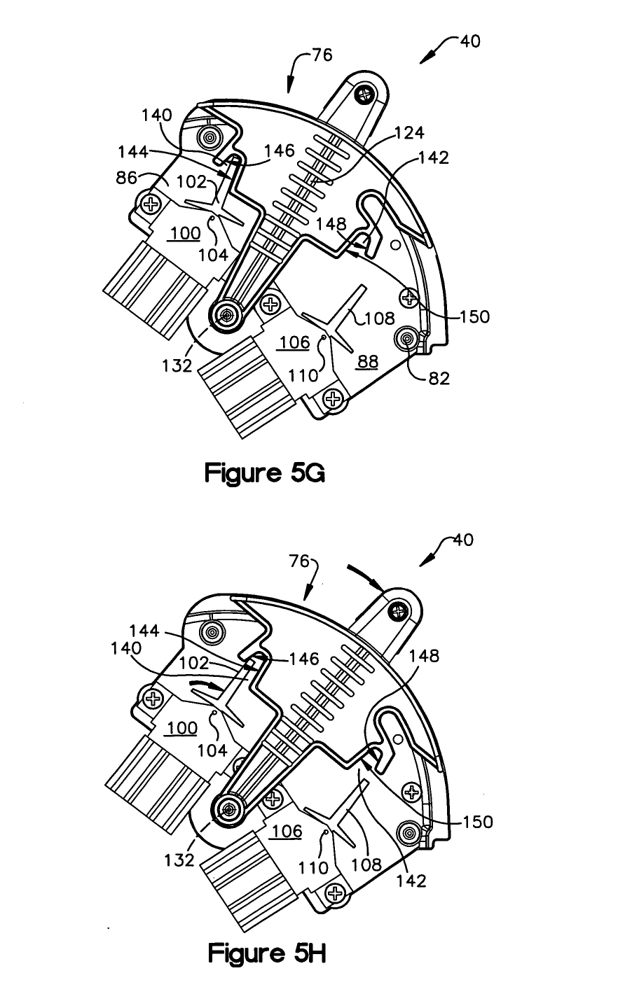

Referring now to FIGS. 5A-5H, the operation of the shifter 40 is schematically shown. In FIG. 5A, the shifter 40 is shown with the actuator 76 in a setting corresponding to the condition whereat the drive assembly 16 drives the wheels 14 forward at a low speed (i.e., the forward-low condition). In this setting, the central axis portion 124 of the actuator 76 is positioned centrally between the direction and speed-switch-interacting areas 86 and 88. The direction switch toggle 102 is in its front position (i.e., its forward-direction setting) and projects into the direction-switch-interacting slot 140 of the actuator 76. The speed switch toggle 108 is in its rear position (i.e., its low-speed setting) and projects into the speed-switch-interacting slot 142 of the actuator 76.

In FIG. 5B, the shifter 40 is shown with the actuator 76 moving from its forward-low setting (FIG. 5A) to a setting corresponding to the condition whereat the drive assembly drives the wheels 14 forward at a high speed (i.e., the forward-high condition). During this movement, the actuator 76 is moved forward and the rear wall 150 of the speed-switch-interacting slot 142 contacts the toggle 108 of the speed switch 74 and pushes it frontward. The direction-switch-interacting slot 140 moves away from the toggle 102 and because of the shorter length of the rear wall 146, the toggle 102 withdraws from the slot 140 while it is still in its front position (i.e., its forward-direction position).

In FIG. 5C, the shifter 40 is shown with the actuator 76 in its forward-high setting. In this setting the central axis portion 124 of the actuator 76 is slanted towards the speed-switch-interacting area 88. The direction switch toggle 102 is still in its front position (i.e., forward-direction position) and removed from the slot 140. The speed switch toggle 108 has been moved to its front position (i.e., its high-speed position) and still projects into the slot 142 of the actuator 76.

In FIG. 5D, the shifter 40 is shown with the actuator 76 moving from its forward-high setting (FIG. 5C) back to the its forward-low setting. During this movement, the actuator 76 is moved rearward and the front wall 148 of the slot 142 contacts the speed switch toggle 108 and pushes it rearward. The direction switch toggle 102 is re-inserted into the slot 140 but is not pushed/pulled by either of its walls 144/146.

In FIG. 5E, the shifter 40 is shown after its return from the forward-high setting to its forward-low setting. As in FIG. 5A, the central axis portion 124 is positioned centrally between the direction and speed-switch-interacting areas 86 and 88, the direction switch toggle 102 is in its front position (i.e., its forward-direction position) and projects into the slot 140, and the speed switch toggle 108 is in its rear position (i.e., its low-speed position) and projects into the slot 142.

In FIG. 5F, the shifter 40 is shown with the actuator 76 moving from its forward-low setting (FIG. 5E) to a setting corresponding to the condition whereat the drive assembly 16 drives the wheels 14 in reverse at a low speed (i.e., the reverse-low condition). During this movement, the actuator 76 is moved rearward and the front wall 144 of the direction-switch-interacting slot 140 contacts the direction switch toggle 102 and pushes it rearward. Because of the shorter length of the front wall 148 of the speed-switch-interacting slot 142, the speed switch toggle 108 is withdrawn from the speed-switch-interacting slot 142 while it is still in its rear position (i.e., its low-speed setting).

In FIG. 5G, the shifter 40 is shown in its reverse-low setting. In this setting, the central axis portion 124 of the actuator 76 is slanted towards the direction-switch-interacting area 86, the direction-switch toggle 102 is in its rear position (i.e., its reverse-direction position) and still projects into the direction-switch-interacting slot 140, and the speed-switch toggle 108 remains in its front position (i.e., its low-speed position) outside of the speed-switch-interacting slot 142.

In FIG. 5H, the shifter 40 is shown with the actuator 76 moving from its reverse-low setting (FIG. 5G) back to its forward-low setting (FIG. 5A). During this movement, the actuator 76 is moved frontward and the rear wall 146 of the direction-switch-interacting slot 140 contacts the toggle 102 of the direction switch 72 and pushes it frontward. The speed switch toggle 108 is re-inserted into the speed-switch-interacting slot 142, but is not pushed/pulled by either of its walls 148/150.

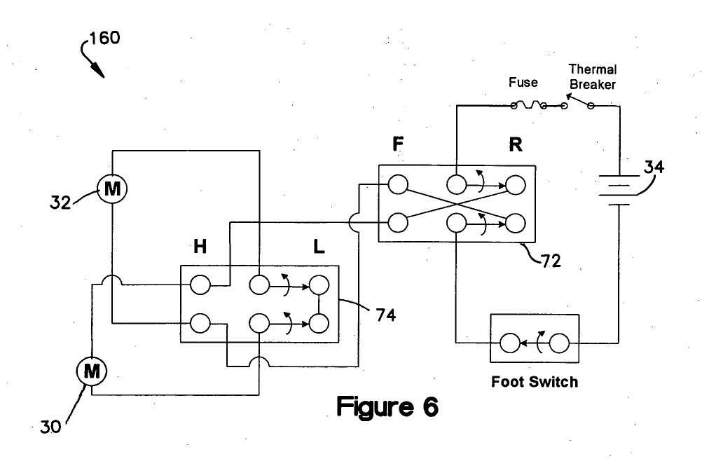

Referring now to FIG. 6, an electrical diagram of a circuit 160 of the drive assembly 16 is schematically shown. The circuit 160 can include a thermal breaker and/or fuse if necessary or desired. The motors 30 and 32 are connected to the speed switch 74 which is connected to the direction switch 72 which is connected to the battery 34. When the direction switch toggle 102 is moved to its reverse setting, the polarity of the battery source 34, and thus the direction of the motors 30/32, is reversed. When the speed switch toggle 102 is in its low setting, the motors 30/32 are arranged in series and, when the speed switch toggle 102 is in its high setting, the motors 30/32 are arranged in parallel. In addition, a foot switch may be included in the circuit 160. This foot switch would allow the child to energize the motors 30/32 in much the same way as acceleration is accomplished in an adult-size vehicle.

It may be noted that the circuit 160 electrically allows for the possibility of a setting whereat the drive assembly 16 drives the wheels 14 at a high speed in a reverse direction. However, the illustrated design of the shifter 40 precludes such a condition. Specifically, the direction-switch toggle 102 must be placed in its front position (i.e., its forward-direction position) prior to the speed-switch-interacting slot 142 engaging the speed switch toggle 108. Likewise, the speed-switch toggle 108 must be placed in its rear position (i.e., its low-speed position) prior to the direction-switch-interacting slot 140 engaging the direction switch toggle 102. Thus, the shifter 40 mechanically prevents a situation whereat the direction-switch toggle 102 is in its rear position (i.e., its rear-direction position) at the same time as the speed-switch toggle 108 is in its front position (i.e., its high-speed position).

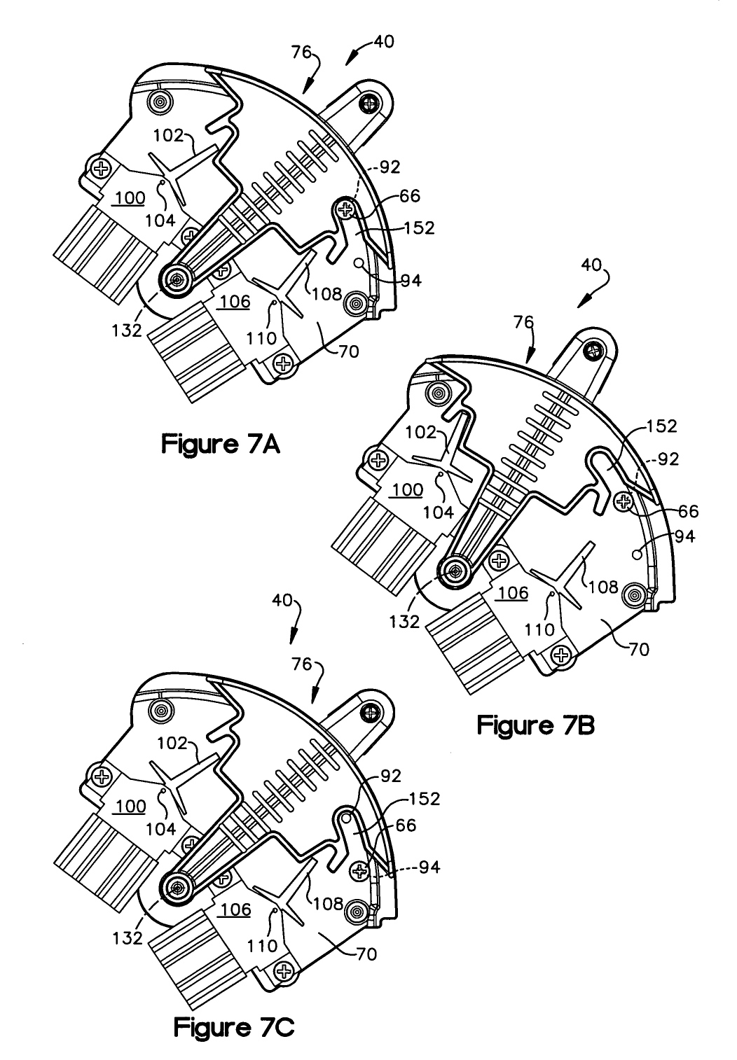

Referring now to FIGS. 7A-7C, a high-speed-lockout feature of the shifter 40 is schematically shown. This high-speed lockout feature allows an adult supervising the operation of the vehicle 10 to selectively preclude a child from driving the vehicle 10 at a high forward speed. This preclusion may be desirable, for example, when a child is first learning to drive the riding vehicle 10 and/or when circumstances require only low-speed driving.

The high-speed-lockout feature is utilized by inserting the high-speed lockout screw 66 in the opening 62 in the housing 42 and then through the opening 92 in the frame 70. In the illustrated embodiment, this insertion can be accomplished from outside of the housing 42 whereby disassembly of the shifter 40 is not necessary. In any event, this insertion of the high-speed lockout screw 66 results in it being positioned at the rear end of the high-speed lockout slot 152 when the actuator 76 is in its forward-low setting, thereby blocking frontward movement of the actuator 76 to its high-speed setting. (See FIG. 7A.) When the high-speed-lockout feature is being used (i.e., the high-speed lockout screw 66 is inserted into the opening 62/92), the actuator 76 can still be moved rearward to its reverse-low setting for “backing up” of the vehicle 10. (See FIG. 7B.) To “unlock” the actuator 76 to allow high-speed operation of the vehicle 10, the high-speed lockout screw 66 is removed from the opening 62/92 and, preferably, inserted into storage openings 64/94 for safe keeping. (See FIG. 7C.)

One may now appreciate that a shifter 40 is provided to shift the drive assembly 16 of a child's riding vehicle 10 among a forward-high condition (whereat it drives the wheels forward at a high speed), a forward-low condition (whereat it drives the wheels forward at a low speed), and a reverse-low condition (whereat it drives the wheels in reverse at a low speed). Although the invention has been shown and described with respect to certain preferred embodiments, it is evident that equivalent and obvious alterations and modifications will occur to others skilled in the art upon the reading and understanding of this specification.

1. A child's riding vehicle comprising a vehicle body adapted to carry a child, wheels rotatably connected to a drive assembly, the drive assembly for driving the wheels, and a shifter for shifting the drive assembly among: a forward-high condition whereat it drives the wheels forward at a high speed, a forward-low condition whereat it drives the wheels forward at a low speed, and a reverse-low condition whereat it drives the wheels in reverse at a low speed; the shifter comprising:
a direction switch including a toggle movable between a forward-direction position and a reverse-direction position, the direction switch being in the forward-direction position when the drive assembly is in the forward-high condition and the forward-low condition, and the direction switch being in the reverse-direction position when the drive assembly is in the reverse-low condition,
a speed switch including a toggle movable between a high-speed position and a low-speed position, the speed switch being in the high-speed position when the drive assembly is in the forward-high condition, and the speed switch being in the low-speed position when the drive assembly is in the forward-low condition and when the drive assembly is in the reverse-low condition, and
an actuator interactable with the direction switch and the speed switch and movable among a forward-high setting, a forward-low setting, and a reverse-low setting to shift the drive assembly among the forward-high condition, the forward-low condition and the reverse-low condition, respectively;
wherein the actuator includes a direction-switch-interacting slot into which the toggle of the direction switch is inserted when it is moved between the forward-direction position and the reverse-direction position and a speed-switch-interacting slot into which the toggle of the speed switch is inserted when it is moved between the high-speed position and the low-speed position.

2. A child's riding vehicle as set forth in claim 1, wherein the toggle of the direction switch is inserted into the direction-switch-interacting slot when the actuator is in its forward-low setting and its reverse-low setting and withdrawn therefrom when the actuator is in its forward-high setting; and
wherein the toggle of the speed switch is inserted into the speed-switch-interacting slot when the actuator is in its forward-low setting and its forward-high setting and withdrawn therefrom when the actuator is in its reverse-low setting.

3. A child's riding vehicle as set forth in claim 1, wherein the direction-switch-interacting slot is defined by a first wall and a second wall, wherein the first wall pushes the toggle of the direction switch from the reverse-direction position to the forward-direction position when the actuator is moved from the reverse-low setting to the forward-low setting, and wherein the second wall pushes the toggle of direction switch from the forward-direction position to the reverse-direction position when the actuator is moved from the forward-low setting to the reverse-low setting;
wherein the speed-switch-interacting slot is defined by a first wall and a second wall, wherein the first wall pushes the toggle of the speed switch from the high-speed position to the low-speed position when the actuator is moved from the forward-high setting to the forward-low setting, and wherein the second wall pushes the toggle of the speed switch from the low-speed position to the high-speed position when the actuator is moved from the forward-low setting to the forward-high setting.

4. A child's riding vehicle as set forth in claim 3, wherein the second wall of the direction-switch-interacting slot is sized so that the toggle of the direction switch withdraws from this slot when the actuator is moved from the forward-low setting to the forward-high setting and wherein the first wall of the speed-switch-interacting slot is sized so that the toggle of the speed switch withdraws from this slot when the actuator is moved from the forward-low setting to the reverse-low setting.

5. A child's riding vehicle as set forth in claim 1, wherein the direction-switch toggle pivots about a pivot axis to move between the forward-direction position and the reverse-direction position, and the speed-switch toggle pivots about a pivot axis to move between the high-speed position and the low-speed position.

6. A child's riding vehicle as set forth in claim 5, wherein the actuator moves in a plane as it moves among the forward-high setting, the forward-low setting, and the reverse-low setting and wherein the pivot axes of the switch toggles are non-parallel with the plane of movement of the actuator.

7. A child's riding vehicle as set forth in claim 6, wherein the pivot axes of the switch toggles are substantially perpendicular to the plane of movement of the actuator.

8. A child's riding vehicle a set forth in claim 5, wherein the actuator pivots about a pivot axis as it moves among the forward-high setting, the forward-low setting, and the reverse-low setting and wherein the pivot axis of the actuator is substantially parallel to the pivot axes of the switch toggles.

9. A child's riding vehicle as set forth in claim 1, wherein the shifter comprises a blocking mechanism which blocks the actuator from moving from the forward-low setting to the forward-high setting.

10. A child's riding vehicle as set forth in claim 9, wherein the blocking mechanism is selectively inserted through a slot in the actuator.

11. A child's riding vehicle as set forth in claim 1, wherein the shifter further comprises a frame, and wherein the actuator includes a stem portion pivotally connected to the frame and an interacting portion including the direction-switch-interacting slot and the speed-switch-interacting slot.

12. A child's riding vehicle as set forth in claim 11, wherein the shifter further comprises a housing within which the frame and the interacting portion of the actuator are situated and wherein the actuator further comprises a handle portion accessible from outside of the housing.

13. A child's ride-on vehicle comprising a vehicle body adapted to carry a child, wheels rotatably connected to the vehicle body, and a drive assembly for driving the wheels, the drive assembly including a shifter for shifting among a forward-high condition whereat the wheels are driven forward at a high speed, a forward-low condition whereat the wheels are driven forward at a low speed, and a reverse-low condition whereat the wheels are driven in reverse at a low speed; the shifter comprising:
a direction switch pivotal about a pivot axis between a forward-direction position and a reverse-direction position, the direction switch being in the forward-direction position when the drive assembly is in the forward-high condition and the forward-low condition, and the direction switch being in the reverse-direction position when the drive assembly is in the reverse-low condition;
a speed switch pivotal about a pivot axis between a low-speed position and a high-speed position, the speed switch being in the low-speed position when the drive assembly is in the forward-low condition and when the drive assembly is in the reverse-low condition, and the speed switch being in the high-speed position when the drive assembly is in the forward-high condition;
an actuator interacting with the direction switch and the speed switch, and pivotal about a pivot axis among a forward-high setting, a forward-low setting, and a reverse-low setting to place the drive assembly in the forward-high condition, the forward-low condition and the reverse-low condition, respectively; and
wherein the pivot axis of the direction switch, the pivot axis of the speed switch, and the pivot axis of the actuator are substantially parallel.

14. A child's ride-on vehicle as set forth in claim 13, wherein the actuator must pass through the forward-low setting to move between the reverse-low setting and the forward-high setting.

15. A child's riding vehicle as set forth in claim 13, wherein the actuator prevents the direction switch from being in the reverse-direction position when the speed switch is in the high-speed position and prevents the speed-switch from being in the high-speed position when the direction switch is in the reverse-direction position.

16. A child's ride-on vehicle comprising a vehicle body adapted to carry a child, wheels rotatably connected to a drive assembly, and the drive assembly for driving the wheels, the drive assembly including a shifter for shifting among a forward-high condition whereat the wheels are driven forward at a high speed, a forward-low condition whereat the wheels are driven forward at a low speed, and a reverse-low condition whereat the wheels are driven in reverse at a low speed; the shifter comprising:
a direction switch having a toggle pivotal about a pivot axis between a forward-direction position and a reverse-direction position, the direction switch being in the forward-direction position when the drive assembly is in the forward-high condition and the forward-low condition, and the direction switch being in the reverse-direction position when the drive assembly is in the reverse-low condition;
a speed switch having a toggle pivotal about a pivot axis between a low-speed position and a high-speed position, the speed switch being in the low-speed position when the drive assembly is in the forward-low condition and when the drive assembly is in the reverse-low condition, and the speed switch being in the high-speed position when the drive assembly is in the forward-high condition;
an actuator interacting with the direction switch and the speed switch, and pivotal about a pivot axis among a forward-high setting, a forward-low setting, and a reverse-low setting to place the drive assembly in the forward-high condition, the forward-low condition and the reverse-low condition, respectively;
wherein the actuator includes a direction-switch-interacting slot into which the toggle of the direction switch is inserted when the actuator is moved between from the forward-low setting and the reverse-low setting and from which the toggle of the direction switch is withdrawn when the actuator is moved from the forward-low setting to the forward-high setting;
wherein the actuator includes a speed-switch-interacting slot into which the toggle of the speed switch is inserted when the actuator is moved between from the forward-low setting and the forward-high setting and from which the toggle of the speed switch is withdrawn when the actuator is moved from the forward-low setting to the reverse-low setting; and
wherein the actuator must pass through the forward-low setting to move between the reverse-low setting and the forward-high setting whereby the toggle of the direction switch is in the forward-direction position and withdrawn from the direction-switch-interacting slot when the actuator is in the forward-high setting and whereby the toggle of the speed switch is the low-speed position and withdrawn from the speed-switch-interacting slot when the actuator is in the reverse-low setting.

17. A child's riding vehicle as set forth in claim 16, wherein the pivot axis of the direction switch, the pivot axis of the speed switch, and the pivot axis of the actuator are substantially parallel.
